(19) United States
(12) Patent Application Publication
(10) Pub. No.: US 2009/0101264 A1
(43) Pub. Date: Apr. 23, 2009

(54) Pneumatic tyre for vehicle, method and apparatus for its manufacture

(76) Inventors: Gaetano Lo Presti, Milano (IT); Noto Rodolfo, Milano (IT); Ignazio De Gese, Milano (IT); Giovanni Pozzati, Milano (IT); Massimo Loprevite, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/665,995

(22) PCT Filed: Oct. 27, 2004
(86) PCT No.: PCT/IT04/00592

§ 371 Date: Apr. 23, 2007

(51) Int. Cl. B60C 1/00; B29D 30/30; B29D 30/52; B60C 5/12

(52) U.S. Cl. 152/510; 152/548; 152/555; 156/128.1; 156/123; 156/130; 156/394.1

(57) ABSTRACT

In a tyre for vehicle wheels, the tread band sidewalls and/or other structural elements of elastomer material have a layered structure which includes at least one first component and at least one second component of a material with different composition from that of the first component. The first and second components have an undulated interface profile, defining elements of mutual mechanical engagement. Also described is a process and an apparatus for manufacturing a tyre.

The present invention relates to a pneumatic tyre for vehicle wheels having a tread band and/or sidewalls and/or other structural elements made up of portions of different blends of elastomer material.

It is a further object of the invention to provide a method of manufacturing said tyre.

A tyre for vehicle wheels generally comprises a carcass structure including at least one carcass ply formed of reinforcing cords incorporated into an elastomer matrix. The carcass ply has end flaps in engagement with annular anchoring structures respectively, that are located at the regions currently identified as “beads”, each of them being usually formed of a substantially circumferential annular insert to which at least one filling insert is applied, at a radially external position.

Associated with the carcass ply, at a radially external position, is a belt structure comprising one or more belt layers, disposed in radial superposed relationship with each other and having textile or metallic reinforcing cords with a crossed orientation and/or substantially parallel to the circumferential extension direction of the tyre. A tread band is applied to the belt structure, at a radially external position; said tread band too is of elastomer material like other constituent structural elements of the tyre. To the aims of the present description it is to be pointed out that by the term “elastomer material” it is intended a composition comprising at least one elastomeric polymer and at least one reinforcing filler. Preferably, this composition further comprises additives such as a cross-linking agent and/or a plasticizer. Due to the presence of the cross-linking agent, this material can be cross-linked through heating so as to form the final article of manufacture.

In addition, respective sidewalls of elastomer material are applied to the side surfaces of the carcass structure, each extending from one of the side edges of the tread band until close to the respective annular anchoring structure to the beads.

In tyres of the “tubeless” type, the carcass ply is fully coated with a layer of butyl-based elastomer material, usually referred to as “liner”, having optimal airtightness features and extending from one bead to the other.

In tyres of the run flat type or for other particular uses, the carcass structure can be also provided with auxiliary reinforcing inserts of elastomer material, located at an axially internal position to each of the sidewalls. These auxiliary inserts, usually called “sidewall inserts”, lend themselves to support the load transmitted to the wheel in case of accidental deflation of the tyre, to allow the vehicle to go on running under safety conditions.

The sidewalls, tread band, possible auxiliary inserts, liner and/or any other structural element of elastomer material integrated into the tyre structure are usually made of blends of materials that are different from each other, each of them being selected depending of the specific operating features required for the respective structural element.

U.S. Pat. No. 6,279,633 proposes manufacture of the sidewalls using an EPDM-based (EPDM=a non-conjugated ethylene-propylene-diene terpolymer) elastomer material containing a siliceous reinforcing filler, to obtain a good resistance to ageing and the possibility of giving the sidewalls a desired colour.

Document US 2004/0103974 teaches how to apply labels of natural rubber containing until 50% of pigments of titanium dioxide to the tyre sidewalls or the tread, in order to reproduce inscriptions and/or tyre identification codes thereon.

In documents US 2003/0127170 and WO 01/94453 use of a surface treatment based on a polyurethane water dispersion is proposed to improve the resistance to ageing of the elastomer material constituting the sidewalls.

EP 0 105 822 discloses a tyre the tread band of which contemplates a plurality of layers in which the outer layers have properties of resistance to wear and tearing, whereas the inner layers have a good behaviour to heating.

U.S. Pat. No. 6,598,646 proposes arranging of the cords of the carcass ply between different covering layers of elastomer material, in which the only layer facing the inside of the tyre is made of butyl rubber to avoid early separation of the tyre components from the carcass ply.

U.S. Pat. No. 4,704,176 proposes improving of the adhesion between a polyurethane blend and a blend based on natural rubber and styrene/butadiene copolymers that are used to make the tyre tread and carcass respectively or vice versa, by applying a surface coating to the cured rubber, which coating consists of a graft polymer based on metylmethacrylate/natural rubber on which a polyurethane reaction blend in a liquid state, which will be submitted to vulcanisation, is subsequently distributed to create a bond with the subsequently applied components based on a polyurethane blend.

The Applicant has ascertained that selection of the materials for the manufacture of the different structural tyre elements is conditioned by the difficulties that can arise for obtaining an efficient and reliable union between the different elastomer materials. In particular the polymeric bases used in the different materials can be little compatible with each other, due for example to the insufficient degree of co-crosslinking, which impairs reliability and duration of the components made with said materials.

The Applicant has perceived that through use of links or constraints of the mechanical type between the components a stable union between structural elements made of elastomer materials different from each other is made possible, even when said materials are not sufficiently co-crosslinkable.

The Applicant therefore has found that if the structural tyre elements are such made that a mechanical engagement between the contacting surfaces can be obtained, blends that are chemically non-compatible or not sufficiently co-crosslinkable can be mutually coupled in a very reliable and durable manner, because the forces tending to separate the different components, due both to the inflating pressure and to forces transmitted to the tyre during use, are counteracted by the constraining reactions generated between the contact surfaces of the different components, as a result of said mechanical engagement.

More specifically, in accordance with the present invention the different materials required for manufacturing a desired structural element are set in the form of a continuous elongated element and mutually coupled before or during winding of said element on a forming support, so as to obtain a layered coating in which the materials are mutually joined according to an undulated interface profile defining complementary elements of mechanical engagement between the components themselves.

In a first aspect, the invention relates to a pneumatic tyre for vehicle wheels, comprising:
a carcass structure including reinforcing thread elements incorporated in an elastomer matrix;
structural elements of elastomer material associated with said carcass structure;
   wherein at least one of said structural elements comprises:
at least one first component formed of a first elastomer material,
and at least one second component formed of a second elastomer material different from said first elastomer material;
   wherein said first and second components have an undulated interface profile;
   wherein said interface profile defines mechanical-engagement elements between the first and second components.

In a further aspect, the invention relates to a method of manufacturing a tyre for vehicle wheels, comprising the steps of:
forming a carcass structure comprising reinforcing thread elements incorporated in an elastomer matrix;
associating structural elements of elastomer material with said carcass structure;
   wherein the step of associating the structural elements of elastomer material with the carcass structure comprises the steps of:
preparing at least one first elongated element comprising a first raw elastomer material, and at least one second elongated element comprising a second raw elastomer material having a different composition from that of said first elastomer material;
laying said first elongated element on a forming support, into coils wound up around a geometric axis of said forming support so as to form a first component of said structural element;
laying said second elongated element on the forming support, into coils wound up around the geometric axis of said forming support so as to form a second component of said structural element superposed on said first component;
   said first and second components having an undulated interface profile, wherein said interface profile defines elements of mechanical engagement between the first and second components;
curing said tyre.

In a further aspect the invention relates to an apparatus for manufacturing pneumatic tyres for vehicle wheels comprising:
devices designed to form a carcass structure comprising reinforcing thread elements incorporated in an elastomer matrix;
devices for associating structural elements of elastomer material with said carcass structure;
devices for curing said tyre,
   wherein the devices for associating the structural elements of elastomer material with the carcass structure comprise at least one unit for manufacturing said structural elements, which unit comprises:
feeding members to supply at least one first elongated element comprising a first raw elastomer material and at least one second elongated element comprising a second raw elastomer material having a different composition from that of the first elastomer material;
members for laying said first and second elongated elements on a forming support into coils wound up around a geometric axis of said forming support so as to form a first component of said structural element and a second component of said structural element superposed on said first component, respectively;
   said first and second components having an undulated interface profile, wherein said interface profile defines elements of mechanical engagement between the first and second components.

Further features and advantages will become more apparent from the detailed description of a preferred, but not exclusive, embodiment of a pneumatic tyre for vehicle wheels, the related manufacturing method and the manufacturing apparatus in accordance with the present invention.

This description will be taken hereinafter with reference to the accompanying drawings, given by way of non-limiting example, in which:

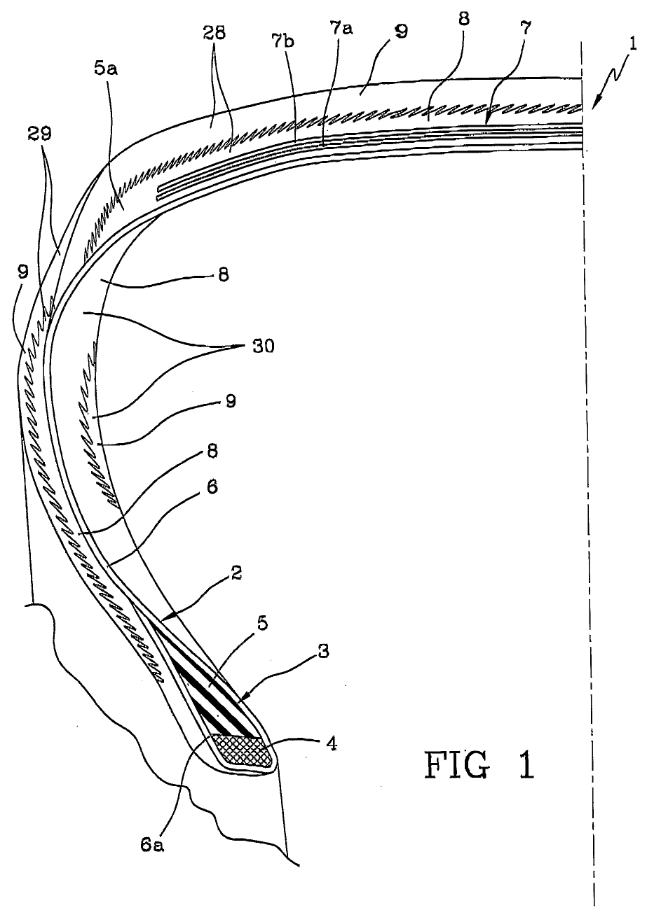

FIG. 1 diagrammatically shows a tyre for vehicle wheels in accordance with the invention, in a fragmentary diametrical section;

FIG. 2 is a fragmentary cross-section to an enlarged scale of a structural element of the tyre in FIG. 1;

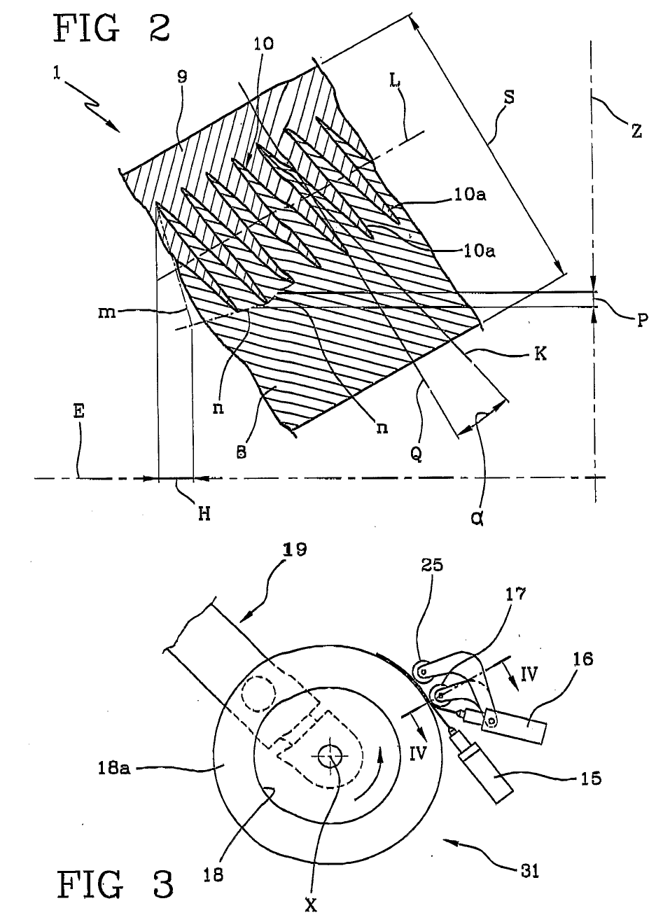

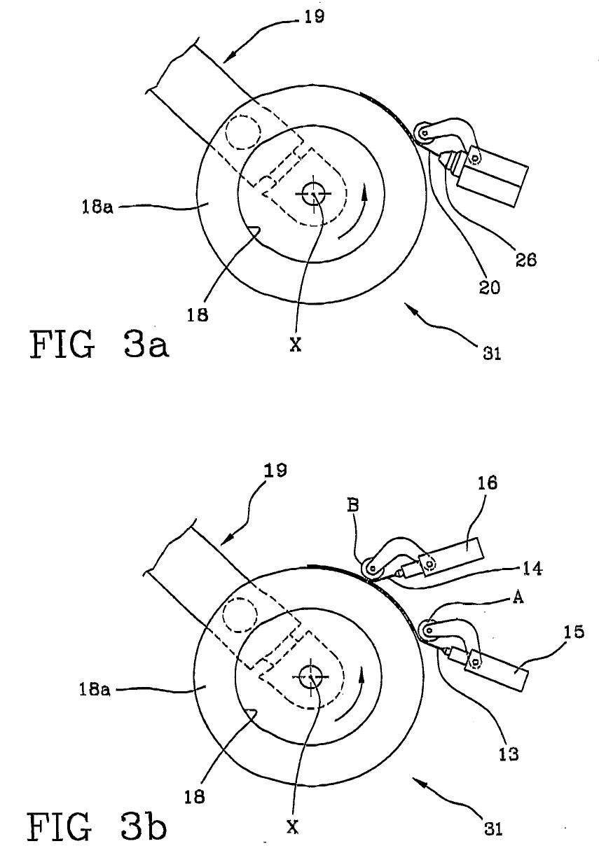

FIG. 3 laterally shows a scheme of the simultaneous laying of a first and a second elongated elements on a forming support, for the purpose of manufacturing a structural element of the tyre in reference;

FIG. 3a laterally shows a scheme of the simultaneous laying of a first and a second elongated elements on a forming support, in accordance with a possible alternative embodiment;

FIG. 3b laterally shows a scheme of the simultaneous laying of a first and a second elongated elements on a forming support, in accordance with a further alternative embodiment;

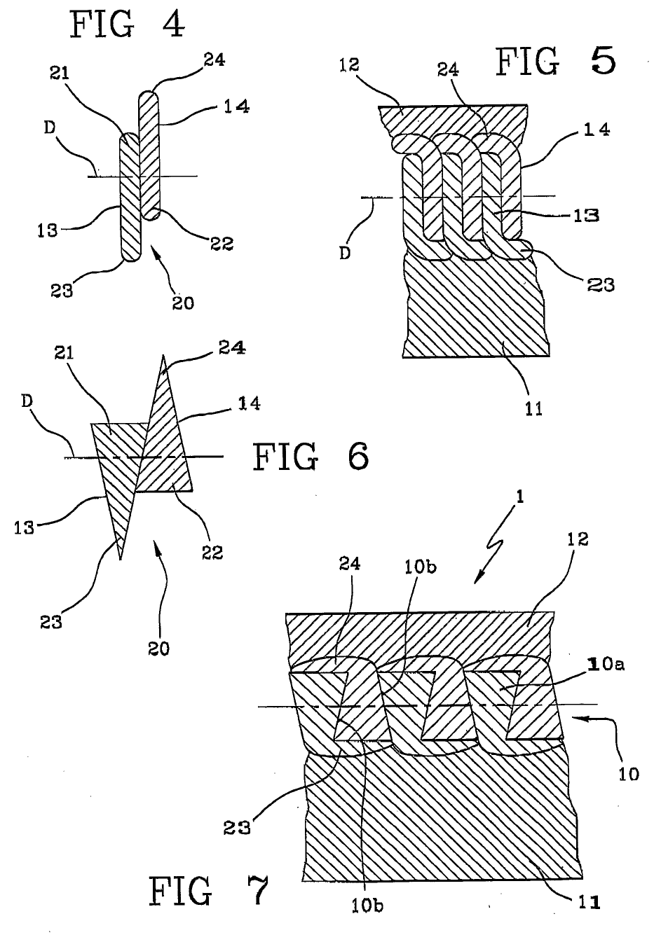

FIG. 4 is a diagrammatic cross-section view of a continuous strip-like element obtainable from mutual coupling of the first and second elongated elements, close to the plane denoted by line IV-IV in FIG. 3;

FIG. 5 shows, by way of example, a scheme of laying the continuous strip-like element in the form of coils disposed close to each other, to obtain a structural element as seen in FIG. 2;

FIG. 6 is a diagrammatic cross-section view of a continuous strip-like element obtainable from coupling of a first and a second elongated elements in a triangular conformation, according to a possible alternative embodiment of the invention;

FIG. 7 is a fragmentary section view of a scheme of laying the continuous strip-like element seen in FIG. 6 in the form of coils disposed close to each other.

With reference to the drawings, a pneumatic tyre for vehicle wheels in accordance with the present invention has been generally identified with reference numeral 1.

In the present specification and in the appended claims by “structural element” of the tyre it is intended any tyre part made of elastomer material such as the tread band, sidewalls, sidewall inserts, fillers, liner and/or under-liner, or a portion thereof, or also the assembly formed of two or more of said parts or portions thereof.

Tyre 1 essentially comprises a carcass structure 2 of a substantially toroidal conformation, and structural elements of elastomer material 5, 28, 29, 30 associated with the carcass structure 2, as better described in the following. In more detail, the carcass structure 2 may for example comprise a pair of annular anchoring structures 3, integrated into the regions usually identified as “beads” and each, for example, consisting of at least one substantially circumferential annular insert 4, currently referred to as “bead core” and formed of one or more rubber-coated cords or equivalent reinforcing thread elements incorporated in an elastomer matrix. An elastomer filler 5 can be applied to the bead core 4, at a radially external position. In engagement with each of the annular anchoring structures 3 are the end flaps 6a of at least one carcass ply 6 comprising textile or metallic rubber-coated cords or equivalent reinforcing thread elements incorporated in an elastomer matrix and extending transversely of the circumferential extension of tyre 2, possibly following a predetermined inclination, from one of the annular anchoring structures 3 to the other.

In tyres of the “tubeless” type, i.e. without an air tube, the carcass structure 2 has a layer of substantially airtight elastomer material generally referred to as “liner” (not shown) at a radially internal position.

Usually associated with the carcass structure 2 are also one or more belt layers 7a, 7b comprising metallic or textile rubber-coated cords, or equivalent reinforcing thread elements incorporated in an elastomer matrix, suitably inclined to the circumferential extension of the tyre preferably following crossed orientations between a belt layer and the other, as well as a possible outer belting layer (not shown) comprising one or more cords circumferentially wound into coils disposed in axial side by side relationship around the belt layers 7a, 7b. The assembly of the belt layers 7a, 7b and the possible outer belting layer defines a so-called belt structure generally denoted at 7, of substantially cylindrical annular conformation, applied to the carcass structure 3 at a radially external position. To the aims of the present specification and the appended claims, the belt structure 7, while described as a distinct component, is considered (when not expressly stated in a different manner) as an integral part of the carcass structure 2.

Further associated with the carcass structure 3 is a tread band 28 circumferentially applied to the belt structure 7 at a radially external position, and a pair of sidewalls 29 laterally applied to the carcass structure 2, on opposite sides.

In run flat tyres or tyres intended for particular uses, auxiliary support inserts 30, of the so-called “sidewall insert” type for example, can be also provided; they are applied either close to the sidewalls 29 internally of the carcass ply 6, as shown by way of example in FIG. 1, or between two paired carcass plies or also at a position axially external to the carcass structure 2.

Tyre 1 lends itself to be manufactured by a manufacturing apparatus essentially comprising devices designed to form the carcass structure 2 and devices for associating with the carcass structure 2, the tread band 28, sidewalls 29, possible auxiliary inserts 30, said liner and/or other structural elements of elastomer material co-operating in forming tyre 1.

In the accompanying drawings, reference numeral 31 denotes a unit for manufacturing structural elements, which unit is part of the devices for associating the structural elements of elastomer material with the carcass structure 2. The other components of the apparatus are not shown, because they can be made in any convenient manner.

For example, the devices for manufacturing tyre 1 may usually comprise a manufacturing line (not shown), in which the carcass structures 2 are obtained, for example, through assembling of carcass plies 6, anchoring structures 3 and/or other parts consisting of semifinished products coming from preceding work and storage steps. Assembling of said parts can be carried out on a so-called “building drum” of the “unistage” type suitable for manufacturing tyres according to a known process currently referred to as “unistage process”; or said assembling can take place on a so-called “first-stage” drum operating in combination with a so-called “shaping drum” suitable for manufacturing tyres according to a known process currently referred to as “two-stage process”.

Usually combined with the manufacturing line is a belt-forming line comprising devices for making the belt layer or layers 7a, 7b, and devices for transferring the belt structure 7 to a coaxially centred position on the unistage drum or the shaping drum so as to associate the belt structure 7 at a radially external position with the carcass structure 2 when the latter, first made in the form of a cylindrical sleeve, is shaped into a toroidal configuration.

Alternatively, the carcass structure 2 and/or the respective belt structure 7 can be formed on at least one forming support that, through one or more robotized arms or other suitable devices, is sequentially brought to interact with one or more work stations located along the manufacturing line, to directly form on the forming support itself, the carcass ply 6, annular anchoring structures 3, belt layers 7a, 7b and/or other constituent elements of tyre 1 through laying of elementary components such as rubber-coated cords, strips of rubber-coated cords and/or elongated elements of elastomer material, as described for example in document U.S. Pat. No. 6,457,504 in the name of the same. Applicant.

The structural elements of elastomer material in tyre 1, such as the tread band 28, sidewalls 29, auxiliary inserts 30, liner, or at least one of them, are preferably made by winding at least one continuous strip-like element of elastomer material into contiguous circumferential coils around a forming support 18, as described in document WO2004/041522 in the name of the same Applicant, for example.

The forming support 18 can consist of a rigid drum conforming in shape to the inner surface extension of the tyre or having another selected configuration depending on the geometrical features of the structural element to be obtained. Alternatively, the forming support 18 can be represented by the carcass ply 6 possibly in turn disposed on a rigid drum, or by other component of the carcass structure 2, such as the belt structure 7, previously associated with the carcass structure 2 itself or not.

In more detail, the liner, possible auxiliary inserts 30 and/or other structural elements disposed at the inner surfaces of tyre 1, or to be applied to the carcass structure 2 at a second time, can be directly made on a forming support 18 in the form of a rigid drum. Other structural elements such as the sidewalls 29 can be directly made against the side surfaces of the carcass ply 6. The tread band 28 can in turn be made at a radially external position to the carcass structure 2 and more specifically on the belt structure 7, before or after assembling of said belt structure with the carcass structure 2.

In a preferred embodiment, at least one of the structural elements 5, 28, 29, 30 of elastomer material can be made with the aid of the above mentioned unit 31.

More specifically, each structural element 5, 28, 29, 30 can consist of at least one first component 8 of a first elastomer material, and one second component 9 of a second elastomer material different from the first elastomer material. The first and second components 8, 9 are advantageously coupled at an undulated interface profile 10 defining mechanical-engagement elements 10a between said two components 8, 9.

In a preferential embodiment, the first elastomer material composing component 8 consists of a blend based on natural rubber or in any case a blend co-crosslinkable with the elastomer matrix used in making the carcass structure and/or the belt layers.

The second elastomer material constituting the second component 9 can in turn consist of a material having any composition adapted to give the component the desired properties.

For example, in manufacturing the sidewalls 29, the second component 9 located at an axially external position to the first component, can advantageously consist of a polymeric base comprising ethylene-propylene-diene (EPDM) rubbers, polyurethane rubbers, butyl rubbers or mixtures thereof, so as to achieve satisfactory properties of resistance to ageing, easy capability of also printing coloured inscriptions, brightness or other desired features in surface appearance.

In the support inserts 30, on the contrary, the second component 9 axially positioned internally of the first component can advantageously comprise a butadiene rubber-based blend, so as to achieve satisfactory properties of resistance to fatigue and low hysteresis.

With reference to the manufacture of the tread band 28, should the carcass structure 2 be made with use of an airtight elastomer material, of a butyl rubber-based blend for example, the first elastomer material composing component 8, located at a radially internal position, can use a butyl rubber-based blend too, or in any case a blend co-crosslinkable with the elastomer matrix used in manufacturing the carcass structure 2 (and/or the belt layers 7a, 7b).

The second elastomer material constituting the second component 9, placed at a radially external position to the first component, can advantageously consist of a blend based on a natural or synthetic rubber (polybutadiene or butadiene-styrene copolymers) so as to ensure satisfactory qualities of roadholding and resistance to abrasion.

The liner could be made in the same manner, i.e. making the first radially internal component 8 with an airtight blend, based on butyl rubber for example, and the second component 9 that in this case would form the so-called under-liner, with a compatible blend, i.e. a blend adapted to be co-crosslinked with the blend used for the remaining part of the carcass structure radially and axially external to the liner/under-liner assembly.

It can be seen that in this way any problem resulting from the difficulty of joining blends different from each other in a stable and reliable manner is overcome, even if these blends are little compatible with each other in terms of creation of chemical cross-linking bonds.

Thus, in making each structural element of tyre 1 it is possible to use the most appropriate materials for obtaining the desired physical and operational features, without impairing the anchoring stability of the different components during use.

As shown in FIG. 1, the first component 8 can advantageously extend over the whole extension of the respective component as shown by way of example with reference to the tread band 28, even if it is also possible for the second component 9 to extend limitedly to a desired surface portion of the first component 8, as shown in connection with the sidewalks 29 and auxiliary inserts 30.

As shown in FIG. 2, in the undulated interface profile 10 it is possible to identify a wave pitch P and a wave height H. Within the present specification and the appended claims, by the term wave “pitch” of the interface profile it is intended the distance P measured in an axial direction in right section between the median points of two consecutive waves. In the context of the present definition, the median point of each wave is the mean point of segment “n” joining the opposite radially inner ends of said wave. In FIG. 2 the line Z on which value P is indicated is parallel to the geometric rotation axis X of the forming support 18 and therefore represents the axial direction. Here and in the following of the specification and in the claims the radial direction E is indicated perpendicularly to line Z.

Finally, in the present specification and in the following claims by “height” of each wave of said interface profile it is intended the projection H on a plane parallel to the equatorial plane (that in the embodiment shown is coincident with the radial direction E) of the forming support 18, of a segment “m” extending in a right-section plane perpendicularly to segment “n” joining said radially inner wave ends, or to the extension of the segment itself, between said segment or the segment extension and the radially outermost point of the wave.

To achieve an efficient mechanical engagement between components 8 and 9, the wave height H is preferably equal to or higher than one tenth of, and preferably higher than half the wave pitch P, so as to obtain effective mechanical-engagement elements 10a also in the absence of undercuts.

In the embodiment shown in FIG. 2, the wave height H is as high as about two times the value of the wave pitch P.

It can be also advantageously provided for the waves defining the undulated profile 10 to have an extension, identifiable by the bisecting line K of the vertex of each wave, which is inclined to a direction Q normal to a median line L of the extension of the undulated profile itself, even to a greater extent than as shown in FIG. 2. More specifically, in accordance with a preferred embodiment, to provide a particular mechanical engagement, the inclination angle α included between said bisecting line K and the perpendicular Q to the median line L is in the range of about 30° to about 88°, and more preferably between about 60° and about 85°.

A suitable value of the inclination angle α, among other things, allows an efficient coupling between the first and second components to be ensured even when the structural element of which they are part has a very restricted extension.

In addition or as an alternative to the above description, the complementary mechanical-engagement elements 10a defined by the interface profile 10 may be provided to have portions 10b of mutual undercut constraint, as shown in FIG. 7.

As viewed from FIGS. 5 and 7, a third component of elastomer material 11 may be further provided, said component being disposed at a radially internal position to the first component 8 and being co-crosslinked with the elastomer material forming the first component.

If required, a fourth component of elastomer material 12 may be also arranged at a position radially external to the second component 9, said fourth component being cross-linked with the elastomer material belonging to at least the second component itself.

Manufacture of each structural element 28, 29, 30 by unit 31 involves preparation of a first elongated element 13 and a second elongated element 14 made of the first and second raw elastomer materials, respectively. The first and second elongated elements, obtained by extrusion and fed from a first 15 and a second 16 extruders respectively, or other feeding members, are guided to at least one roller 17 or other member carrying out laying of them on a deposition surface 18a of the forming support 18. The forming support 18 is preferably supported by a robotized arm 19 only partly shown as it is already known from document WO 00/35666 A1 in the name of the same Applicant. The robotized arm 19 is equipped with a motor or other rotatory driving devices giving the forming support 18 a circumferential-distribution rotatory motion around the geometric rotation axis X thereof, by effect of which a circumferential distribution of the elongated elements 13, 14 laid by the feeding roller 17 on the deposition surface 18a is caused. Simultaneously, translational driving devices associated with the robotized arm 19 move the forming support 18 in front of the feeding roller 17 with controlled relative displacements of transverse distribution, so that the first and second elongated elements 13, 14 are laid on the deposition surface 18a in the form of coils wound around the geometric axis X of the forming support 18.

On coming out of the respective extruders 15, 16, the first and second elongated elements 13, 14 are guided, by effect of the feeding roller 17 or other suitable members, in mutually converging directions towards a point of mutual coupling in which the elongated elements themselves meet and adhere to each other forming a continuous strip-like element 20 that is laid and distributed on the forming support 18 as above described.

In the example in FIG. 3, the coupling point of the elongated elements 13, 14 is coincident with the application of same to the forming support 18 by the feeding roller 17. However said elongated elements 13, 14 can be also guided in such a manner as to cause coupling of same at a point upstream of the forming support 18. It may be also provided that the continuous strip-like element 20 should come from a supply reel, used in a storage step of the strip-like element itself after carrying out mutual coupling of the elongated elements 13, 14.

In a further alternative embodiment, the elongated elements 13, 14 can be co-extruded and directly coupled in the extrusion head of a single extruder 26 (FIG. 3a) so that the strip-like element 20 is directly generated at the extruder outlet.

Finally, in a different embodiment shown by way of example in FIG. 3b, the elongated elements 13, 14 can be simultaneously laid on the forming support 18 at points A, B that are mutually spaced apart in a circumferential direction. In this instance, the coupling point between the elongated elements is coincident with the application point of the second elongated element 14 onto the forming support 18.

As can be viewed from FIGS. 4 and 6, the elongated elements 13, 14 are mutually coupled in such a manner that, when coupling has occurred, each of them has a base portion 21, 22 in contact with the base portion of the other elongated element. In addition, at least one of the elongated elements 13, 14 may have an apex 23, 24 projecting from the base portion 21, 22, in a direction transverse to the direction of mutual alignment of the base portions themselves, denoted at D in said figures.

In more detail, in a preferential embodiment the elongated elements 13, 14 that can have a conformation substantially identical with each other, are coupled at mutually offset positions in a plane transverse to the mutual alignment direction D of the base portions 21, 22, so that each of them has a respective apex 23, 24 projecting in the opposite direction with respect to the apex of the other elongated element.

During laying on the forming support 18, the mutual positioning of the elongated elements 13, 14 and/or orientation of the continuous strip-like element 20 formed by them is controlled in such a mariner that, on coming close to the deposition surface 18a, the apex 23 of the first elongated element 13 is turned towards the forming support 18.

As can be clearly seen looking at FIGS. 5 and 7, apex 23 of the first elongated element 13 during application is deformed and it consequently bends towards the base portion 22 of the second elongated element 14, taking an interposed position between the second elongated element 14 and the forming support 18 so as to avoid a direct contact of the second elastomer material against the deposition surface 18a. At the deposition surface 18a, the coils disposed consecutively in side by side relationship and formed by the first elongated element 13, by effect of bending of apex 23 as above described, give rise to a continuous layer made up of the elastomer material, that extends over the whole deposition surface 18a.

Apex 24 of the second elongated element 14, in turn, is oriented radially away from the deposition surface 18a exhibited by the forming support 18 and can be turned up against the base portion 21 of the first elongated element 13, so that the coils in side by side relationship formed by the second elongated element 14 cause formation of a continuous layer made up of the second elastomer material.

If required, turning up of apex 24 of the second elongated element 14 can be assisted by a roller or other auxiliary applicator member 25, operating downstream of the feeding roller 17.

Furthermore, following deposition in the form of coils in side by side relationship, the base portions 21, 22 of the first and second elongated elements 13, 14 generate the interface profile 10 between the first and second components.

If required, application of the first and second elongated elements 13, 14 can be preceded by application of the third component 11 made of the same blend as that of the elongated element 13 or, in any case, a blend co-crosslinkable with the first elastomer material forming the first elongated element 13. Formation of this third component can take place in the same manner as previously described with reference to laying of the continuous strip-like element 20, i.e. through application of a continuous elongated element of elastomer material coming from an extruder for example and formed into coils disposed consecutively in side by side relationship to cover the deposition surface 18a of the forming support 18.

Subsequently to laying of the first and second elongated elements 13, 14, application of the above mentioned fourth component 12 may be also carried out, said component being made of a material co-crosslinkable with the second elastomer material forming the second elongated element 14. Formation of the fourth component 12 too can be carried out by applying onto the forming support 18, a fourth elongated element of elastomer material corning from an extruder and formed into coils disposed consecutively in side by side relationship. The third and fourth elongated elements can be advantageously produced either by the same extruders 15, 16 used for formation of the first and second elongated elements 13, 14, or by specific extruders dedicated thereto.

In the presence of the third and/or fourth elastomer components 11, 12, arrangement of apices 23, 24 projecting from the first and second elongated elements 13, 14 respectively may appear to be superfluous, as said third and fourth components can be co-crosslinkable with the material forming the base portions 21, 22 of the elongated elements 13, 14, respectively.

As shown in FIG. 5, the elongated elements 13, 14 can have a conformation with a substantially flattened cross-section. In this case an interface profile 10 as shown in FIG. 2 is preferably obtained, in which the wave height H is greatly higher than the wave pitch, so that the hills and valleys of the undulated profile will cause formation of the mechanical-engagement elements. Alternatively, as exemplified in FIGS. 6 and 7, the elongated elements 13, 14 can advantageously have a cross-section profile of triangular conformation. In this case the base portions 21, 22 of the coupled elongated elements 13, 14 give rise to formation of portions 10b with an undercut constraint, in the mechanical-engagement elements 10a. The same effect is achieved using elongated elements 13, 14 having a trapezoidal cross-section profile.

When formation of the structural elements 28, 29, 30 co-operating in the manufacture of tyre 1 together with the carcass structure 2, has been completed, the tyre itself lends itself to be introduced into a mould to be submitted to a moulding and vulcanisation step that can be carried out in any convenient manner.

It will be finally appreciated that union between the different materials is obtained without requiring use of chemical treatments that would increase the working time and costs and would involve use of polluting substances.

In addition, the tyre in reference lends itself to be made in a simple and cheap manner, utilising machinery and equipment already provided in modern tyre-production cycles in which the structural elements of elastomer material are obtained by winding up elongated elements of raw elastomer material into coils disposed in side by side relationship on a forming support, as described in document WO 00/35666 A1 in the name of the same Applicant.

1-60. (canceled)

61. A pneumatic tyre for vehicle wheels, comprising:
a carcass structure comprising reinforcing thread elements incorporated in an elastomer matrix;
structural elements of elastomer material associated with said carcass structure, wherein at least one of said structural elements comprises:
at least one first component formed of a first elastomer material; and
at least one second component formed of a second elastomer material different from said first elastomer material,
wherein said first and second components have an undulated interface profile, and
wherein said interface profile defines mechanical-engagement elements between the first and second components.

62. The tyre as claimed in claim 61, wherein a tread band applied to the carcass structure at a radially external position has said second component disposed at a position radially external to said first component.

63. The tyre as claimed in claim 61, wherein a pair of sidewalls is applied to the carcass structure at laterally opposite positions, at least one of said sidewalls having said second component disposed in a position axially external to the first component.

64. The tyre as claimed in claim 61, wherein a pair of auxiliary support inserts is associated with the carcass structure, at least one of said auxiliary inserts having said second component disposed in a position axially external to the first component.

65. The tyre as claimed in claim 61, wherein a liner and an under-liner are applied to the carcass structure at a radially internal position, said under-liner comprising said second component at a radially external position to said first component forming said liner.

66. The tyre as claimed in claim 61, wherein the interface profile has a wave height and a wave pitch in which the wave height is equal to or higher than one tenth of the wave pitch.

67. The tyre as claimed in claim 66, wherein the wave height is higher than half the wave pitch.

68. The tyre as claimed in claim 66, wherein the wave height is higher than four times the wave pitch.

69. The tyre as claimed in claim 61, wherein said mechanical-engagement elements have portions of mutual undercut constraint.

70. The tyre as claimed in claim 61, wherein said undulated interface profile comprises a plurality of waves having an inclined extension to a direction normal to a median line of extension of the undulated profile.

71. The tyre as claimed in claim 70, wherein each wave has an inclination angle between a bisecting line of a vertex of said wave and said direction normal to the median line of about 30° to about 88°.

72. The tyre as claimed in claim 71, wherein said inclination angle is about 60° to about 85°.

73. The tyre as claimed in claim 61, wherein coupled with said first component is a third component of elastomer material co-crosslinked with at least said first elastomer material.

74. The tyre as claimed in claim 61, wherein coupled with said second component is a fourth component of elastomer material co-crosslinked with at least one of said first and second elastomer material.

75. The tyre as claimed in claim 61, wherein said second component extends along at least one surface portion of the first component.

76. The tyre as claimed in claim 61, wherein said first elastomer material is co-crosslinked with the elastomer matrix of the carcass structure.

77. A method of manufacturing a tyre for vehicle wheels, comprising the steps of:
forming a carcass structure comprising reinforcing thread elements incorporated in an elastomer matrix;
associating structural elements of elastomer material with said carcass structure, wherein the step of associating the structural elements of elastomer material with the carcass structure comprises the steps of:
preparing at least one first elongated element comprising a first raw elastomer material and at least one second elongated element comprising a second raw elastomer material having a different composition from that of said first elastomer material;
laying said first elongated element on a forming support into coils wound up around a geometric axis of said forming support so as to form a first component of said structural element;
laying said second elongated element on the forming support into coils wound up around the geometric axis of said forming support so as to form a second component of said structural element superposed on said first component, said first and second components having an undulated interface profile, wherein said interface profile defines elements of mechanical engagement between the first and second components; and
curing said tyre.

78. The method as claimed in claim 77, wherein laying of the first and second elongated elements is carried out at a radially external position to the carcass structure previously set on the forming support to form a tread band of said tyre.

79. The method as claimed in claim 79, further comprising the steps of setting at least one belt layer and associating said at least one belt layer with the carcass structure, wherein laying of the first and second elongated elements is carried out at a radially external position to said at least one belt layer before or after associating the belt layer with the carcass structure, to form a tread band of said tyre.

80. The method as claimed in claim 77, wherein laying of the first and second elongated elements is carried out laterally against the carcass structure to form at least one sidewall of said tyre.

81. The method as claimed in claim 77, wherein laying of the first and second elongated elements is carried out at an axially external position to the forming support to form at least one support insert before setting the carcass structure on the forming support to apply said at least one support insert laterally to the inside of the carcass structure.

82. The method as claimed in claim 77, wherein said interface profile has a wave height and a wave pitch in which the wave height is at least as high as one tenth of the wave pitch.

83. The method as claimed in claim 82, wherein the wave height is higher than half the wave pitch.

84. The method as claimed in claim 82, wherein the wave height is higher than four times the wave pitch.

85. The method as claimed in claim 77, wherein said undulated interface profile comprises a plurality of waves having an inclined extension to a direction normal to a median line of extension of the undulated profile.

86. The method as claimed in claim 85, wherein each wave has an inclination angle between a bisecting line of a vertex of said wave and said direction normal to the median line that is about 30° to about 88°.

87. The method as claimed in claim 86, wherein said inclination angle is about 60° to about 85°.

88. The method as claimed in claim 77, wherein said mechanical-engagement elements have portions of mutual undercut constraint.

89. The method as claimed in claim 77, wherein at least one of said first and second elongated elements has a flattened cross-section conformation.

90. The method as claimed in claim 77, wherein at least one of said first and second elongated elements has a substantially triangular cross-section conformation.

91. The method as claimed in claim 77, wherein at least one of said first and second elongated elements has a substantially trapezoidal cross-section conformation.

92. The method as claimed in claim 77, further comprising a step of mutually coupling the first and second elongated elements along their longitudinal extension to prepare a continuous strip-like element that is wound around the geometric axis of said forming support during the laying step.

93. The method as claimed in claim 92, wherein the coupling step is carried out before the laying steps.

94. The method as claimed in claim 92, wherein preparation of the continuous strip-like element comprises the steps of:
feeding the first elongated element through a first feeding member;
feeding the second elongated element through a second feeding member simultaneously with feeding of the first elongated element; and
guiding the first and second elongated elements in mutually converging directions toward a point of mutual coupling.

95. The method as claimed in claim 94, wherein feeding of the first and second elongated elements takes place by extrusion through first and second extruders, respectively, said first and second extruders being part of said first and second feeding members.

96. The method as claimed in claim 92, wherein the continuous strip-like element is made by co-extrusion of the first and second elongated elements through the same extruder.

97. The method as claimed in claim 92, wherein the coupling step is carried out simultaneously with winding of the strip-like element on the forming support at a point of mutual coupling between the elongated elements placed on the forming support.

98. The method as claimed in claim 92, wherein the coupling step is carried out simultaneously with winding of the strip-like element on the forming support at a point of mutual coupling between the elongated elements placed upstream of the forming support.

99. The method as claimed in claim 77, wherein the first and second elongated elements are simultaneously laid on the forming support at points mutually spaced apart in a circumferential direction.

100. The method as claimed in claim 92, wherein following the coupling step, each of said elongated elements has a base portion integral with a base portion of the other elongated element, and at least one of said elongated elements has an apex projecting from the base portion transversely of a direction of mutual alignment of the base portions.

101. The method as claimed in claim 100, wherein the first and second elongated elements are coupled at mutually offset positions in a transverse direction relative to a direction of mutual alignment of the base portions so that each elongated element has said apex projecting in the opposite direction relative to the apex of the other elongated element.

102. The method as claimed in claim 100, wherein the apex of an elongated element is turned up against a base portion of the other elongated element.

103. The method as claimed in claim 77, wherein laying of each of said first and second elongated elements comprises the steps of:
feeding the elongated element from a feeding member disposed adjacent to the forming support for application of said elongated element onto the support itself;
giving the forming support a circumferential-distribution rotatory motion around the geometric rotation axis so that the elongated element is circumferentially distributed on the forming support; and
carrying out controlled relative displacements of transverse distribution between the forming support and feeding member to form said coils.

104. The method as claimed in claim 77, further comprising the step of applying at least one third component onto the forming support before application of said first component, said third component being of an elastomer material co-crosslinkable with at least said first elastomer material.

105. The method as claimed in claim 77, further comprising the step of applying a fourth component subsequently to application of said second component, said fourth component being of an elastomer material co-crosslinkable with at least said second elastomer material.

106. The method as claimed in claim 17, wherein said first elastomer material is co-crosslinkable with the elastomer matrix of the carcass structure.

107. An apparatus for manufacturing pneumatic types for vehicle wheels comprising:
devices designed to form a carcass structure comprising reinforcing thread elements incorporated in an elastomer matrix;
devices for associating structural elements of elastomer material with said carcass structure;
devices for curing said tyre, wherein the devices for associating the structural elements of elastomer material with the carcass structure comprise at least one unit for manufacturing said structural elements, which unit comprises:
feeding members to supply at least one first elongated element comprising a first raw elastomer material and at least one second elongated element comprising a second raw elastomer material having a different composition from that of the first elastomer material; and
members for laying said first and second elongated elements on a forming support into coils wound up around a geometric axis of said forming support so as to form a first component of said structural element and a second component of said structural element superposed on said first component, respectively,
said first and second components having an undulated interface profile, wherein said interface profile defines elements of mechanical engagement between the first and second components.

108. The apparatus as claimed in claim 107, wherein said at least one unit for manufacturing structural elements is dedicated to manufacturing tread bands at a radially external position to the carcass structure.

109. The apparatus as claimed in claim 107, further comprising devices for making at least one belt layer and devices for associating said at least one belt layer with the carcass structure at a radially external position, wherein said at least one unit for manufacturing structural elements is dedicated to manufacturing tread bands at a radially external position to said at least one belt layer.

110. The apparatus as claimed in claim 107, wherein said at least one unit for manufacturing structural elements is dedicated to manufacturing sidewalls laterally disposed against the carcass structure.

111. The apparatus as claimed in claim 107, wherein said at least one unit for manufacturing structural elements is dedicated to manufacturing auxiliary support inserts for association with the carcass structure.

112. The apparatus as claimed in claim 107, wherein said at least one unit for manufacturing structural elements comprises:
a first feeding member set to feed the first elongated element;
a second feeding member set to feed the second elongated element; and
devices for guiding the first and second elongated elements in mutually converging directions toward a mutual coupling point.

113. The apparatus as claimed in claim 112, wherein said mutual coupling point between the elongated elements is located on the forming support.

114. The apparatus as claimed in claim 112, wherein said mutual coupling point between the elongated elements is located upstream of the forming support.

115. The apparatus as claimed in claim 112, wherein the guiding devices convey the first and second elongated elements on the forming support to points that are mutually spaced apart in a circumferential direction.

116. The apparatus as claimed in claim 112, wherein said first and second feeding members comprise first and second extruders, respectively.

117. The apparatus as claimed in claim 107, wherein said at least one unit for manufacturing structural elements comprises at least one extruder for co-extrusion of the first and second elongated elements to manufacture said continuous strip-like element.

118. The apparatus as claimed in claim 107, wherein said at least one unit for manufacturing structural elements comprises:
at least one feeding member disposed adjacent to the forming support for application of at least one said elongated elements on the support;
rotatory driving devices to give the forming support a circumferential-distribution rotatory motion around the geometric rotation axis so that the elongated element is circumferentially distributed on the forming support; and
translational driving devices to carry out controlled relative displacements of transverse distribution between the forming support and the feeding member in order to form said coils.

119. The apparatus as claimed in claim 107, wherein said at least one unit for manufacturing structural elements further comprises devices for application on the forming support of at least one third component of elastomer material co-crosslinkable with at least said first elastomer material.

120. The apparatus as claimed in claim 107, wherein said at least one unit for manufacturing structural elements further comprises devices for application on the forming support of a fourth component of elastomer material co-crosslinkable with at least said second elastomer material.
